(19) United States
(12) Patent Application Publication
(10) Pub. No.: US 2023/0220220 A1
(43) Pub. Date: Jul. 13, 2023

(54) Coating Material

(71) Applicant: Nippon Telegraph and Telephone Corporation, Tokyo (JP)

(72) Inventors: Azusa Ishii, Tokyo (JP); Takashi Miwa, Tokyo (JP); Masamitsu Watanabe, Tokyo (JP); Soichi Oka, Tokyo (JP)

(21) Appl. No.: 18/001,045

(22) PCT Filed: Jul. 2, 2020
(86) PCT No.: PCT/JP2020/026031

§ 371 Date: Dec. 7, 2022

(51) Int. Cl. C09D 7/61; C09D 163/00; C09D 5/10

(52) U.S. Cl. CPC C09D 7/61; C09D 163/00; C09D 5/106; C08K 2003/3045

(57) ABSTRACT

A paint contains a zinc powder, a binding agent made of an organic resin, and an inorganic material that is water-soluble and exhibits alkalinity when being dissolved in water. The inorganic material can be, for example, one that provides a saturated aqueous solution having a pH of 12 or less. For example, the basic substance may be barium carbonate, barium hydrogen phosphate, beryllium carbonate, calcium carbonate, calcium hydrogen phosphate, calcium phosphate, lithium carbonate, lithium phosphate, magnesium carbonate, basic magnesium carbonate, magnesium hydroxide, magnesium oxide, or magnesium phosphate.

This patent application is a national phase filing under section 371 of PCT/JP2020/026031, filed Jul. 2, 2020, which is incorporated herein by reference in its entirety.

### TECHNICAL FIELD

The present invention relates to a coating material. Particular embodiments relate to a paint used for protecting a metal surface such as a steel material.

### BACKGROUND

A zinc rich paint is one of the anticorrosive paints that protect a metal material (mainly steel) from corrosion. The zinc rich paint is a paint containing a zinc powder at a high concentration (70 wt % or more after a coating film is dried), and is widely used. The zinc rich paint performs a sacrificial anticorrosive action on a metal nobler than zinc even when a coating film is damaged by the zinc powder contained at a high concentration and a metal of a substrate is exposed. In addition, zinc ions eluted from the zinc powder in the zinc rich paint form a corrosion product of zinc at an exposed portion to become a protective film. As described above, a coating film capable of obtaining an excellent anticorrosive effect due to the sacrificial anticorrosive action and the protective film action by zinc can be formed by the zinc rich paint.

### SUMMARY

### Technical Problem

The anticorrosive effect of the zinc rich paint is due to the sacrificial anticorrosive action and the protective film action of zinc, but these functions are gradually lost as consumption of zinc proceeds in a corrosive environment. In particular, in a portion where a coating film is damaged, zinc is severely consumed, and when zinc in the vicinity of the damage is consumed, an anticorrosive effect by zinc can be hardly obtained, and corrosion of a substrate proceeds at once. In general, the zinc rich paint is used in such a manner that another paint is applied on the zinc rich paint. When the thickness of the coating film to be applied is insufficient, zinc is gradually consumed even in the entire part of the coating film to generate voids, and a corrosion factor easily reaches a substrate to cause rust or swelling. In order to maintain the anticorrosive effect of the zinc rich paint for a long period of time, it is considered that a corrosion rate of zinc needs to be reduced.

In order to cope with the above, a zinc rich paint to which aluminum, an aluminum-magnesium alloy, or the like is added is commercially available for the purpose of reducing the corrosion rate of zinc. In addition, zinc-based alloy plating having a lower corrosion rate than zinc plating is also commercially available, and it is also conceivable to change a powder used for the zinc rich paint to powders of these zinc-based alloys.

However, these techniques lead to an increase in raw material cost, and also have a problem such as difficulty in processing particles so as to have a particle shape and a particle diameter suitable for the zinc rich paint. As described above, in the conventional technique, there is a problem that a zinc powder-containing paint such as the zinc rich paint that maintains an anticorrosive effect for a long period of time cannot be manufactured inexpensively and easily.

Embodiments of the present invention have been made in order to solve the above problem, and an embodiment of the present invention makes it possible to manufacture a zinc powder-containing paint that maintains an anticorrosive effect for a long period of time inexpensively and easily.

### Solution to Problem

A paint according to embodiments of the present invention contains a zinc powder, a binding agent made of a resin, and an inorganic material that is water-soluble and exhibits alkalinity when being dissolved in water.

### Advantageous Effects of Embodiments of the Invention

As described above, according to embodiments of the present invention, a zinc powder-containing paint that maintains an anticorrosive effect for a long period of time can be manufactured inexpensively and easily because an inorganic material that is water-soluble and exhibits alkalinity when being dissolved in water is added to the paint for use.

### DETAILED DESCRIPTION OF ILLUSTRATIVE EMBODIMENTS

Hereinafter, a paint according to an embodiment of the present invention will be described.

The paint according to the embodiment contains a zinc powder, a binding agent made of a resin, and an inorganic material (basic substance) that is water-soluble and exhibits alkalinity when being dissolved in water. The binding agent is a so-called binder, and can be made of a resin capable of forming a coating film (which can be a coating film-forming component). Examples of this resin include an epoxy resin, a polyurethane resin, a fluorocarbon resin, an oil-modified alkyd resin, a phthalic acid resin, an unsaturated polyester resin, a silicone resin, a modified epoxy resin, an alkyl silicate, an alkali silicate-based material, an acrylic silicate, an acrylic styrene resin, a styrene resin, a polyester resin, a chlorinated rubber, a melamine resin, and a polyamide resin. In particular, an epoxy resin, a polyurethane resin, an acrylic styrene resin, a styrene resin, an acrylic resin, an alkyl silicate, an alkali silicate-based material, and the like used as a binder of the zinc rich paint are suitable as the binder.

The inorganic material (basic substance) can be, for example, one that provides a saturated aqueous solution having a pH of 12 or less. For example, the basic substance is at least one selected from barium carbonate, barium hydrogen phosphate, beryllium carbonate, calcium carbonate, calcium hydrogen phosphate, calcium phosphate, lithium carbonate, lithium phosphate, magnesium carbonate, basic magnesium carbonate, magnesium hydroxide, magnesium oxide, and magnesium phosphate.

The content of the basic substance described above is 0.5 to 32 g with respect to 100 g of a heating residue (excluding the basic substance) of a coating film.

In addition, a sulfate having a solubility in water of less than 5 g/100 ml can be added to the paint described above for use. The sulfate is at least one of sodium sulfate and calcium sulfate. The content of the sulfate can be 0.5 to 32 g with respect to 100 g of a heating residue (excluding the basic substance and the sulfate to be added) of a coating film.

For example, the basic substance can be calcium hydrogen phosphate or basic magnesium carbonate or a mixture of magnesium carbonate and magnesium hydroxide, and the sulfate can be calcium sulfate. In this case, the content of the basic substance can be 0.5 to 16 g with respect to 100 g of a heating residue (excluding the basic substance and the sulfate to be added) of a coating film, and the content of the sulfate can be 0.5 to 16 g with respect to 100 g of the heating residue (excluding the basic substance and the sulfate to be added) of the coating film.

Note that, for example, a dispersant can be added to the paint according to the embodiment for use. The dispersant is made of, for example, at least one of a block copolymer having a basic group having pigment affinity, an oil-soluble nonionic activator, and a polyether-modified silicone-based agent. As the dispersant, for example, DISPERBYK-2155 manufactured by BYK, and Floren D-90 and Polyflow KL-401 manufactured by Kyoeisha Chemical Co., Ltd. are suitably used. By using the dispersant, for example, calcium sulfate can be uniformly dispersed in the paint.

Hereinafter, description will be made in more detail using results of experiments.

### Experiment

### Sample Preparation

A water-soluble basic substance that exhibits alkalinity when being dissolved in water (hereinafter, referred to as additive A) and a sulfate (hereinafter, referred to as additive B) were added to a commercially available zinc rich paint (“SD Zinc 500 Mild” manufactured by Kansai Paint Co., Ltd.) to prepare a sample. The addition amount of additive A is wA g with respect to 100 g of a heating residue (excluding additive A and additive B) of a coating film. The addition amount of additive B is wB g with respect to 100 g of the heating residue (excluding additive A and additive B) of the coating film. Note that SD Zinc 500 Mild is a paint (zinc rich paint) containing a zinc powder and a binding agent made of an epoxy resin as main compositions, and conforms to “JIS K 5553 Grade-2 thick film type zinc rich paint”. Therefore, the amount of metallic zinc in the heating residue is at least 70 wt %.

Note that the zinc content of an organic zinc rich paint is usually about 70 to 90 wt %. Many commercially available zinc powder-containing paints such as the zinc rich paint are formed by combining “a liquid obtained by mixing a zinc powder, a resin, and a solvent” and “a curing agent”, and the exact amount of zinc is unknown. Therefore, the addition amounts of additive A and additive B described above were determined by a weight ratio with respect to a heating residue which is a parameter described in a paint manual.

### Coated Test Piece

As a steel sheet to be coated with a sample paint, two types of steel sheets were used: a “blasted SS400 steel sheet” subjected to base adjustment by blasting treatment; and a “post-corrosion grade-2 base-adjusted steel sheet” subjected to grade-2 base adjustment (ISO 8501 St3) after being corroded by a sodium chloride aqueous solution. For each of the steel sheets, a plate material having a size of 150×70 (mm) in plan view and a thickness of 3.2 mm was used.

Each of the sample paints was weighed such that an application (coating) amount was 320 g/m², and a steel sheet was coated with each of the sample paints using a brush. After drying, each of the sample paints was weighed again such that an application (coating) amount was 320 g/m², and the steel plate was coated (overcoated) with each of the sample paints using a brush. The steel plate was coated with 640 g/m² of paint (sample) in total. After coating and drying, an artificial flaw reaching the steel material was formed in an “x” shape using a small blade cutter knife in a lower half region of each of the coated test pieces, and a “coating film damaged portion” for evaluating a sacrificial anticorrosive action and a protective film action on the portion where the coating film was damaged was prepared and used as the coated test piece.

### Evaluation of Anticorrosion Property of Coated Test Piece

Each of the coated test pieces was subjected to a combined cycle test in which salt water spraying, wetting, and drying were repeated. For test conditions of the combined cycle test, the NTT combined cycle test described in Reference Document 1 was performed for 2000 hours. By the way, as described in Reference Document 2, when zinc is corroded in seawater, gordaite having a high protection property is generated by sulfate ions contained in seawater. However, the sodium chloride aqueous solution used in the technique of Reference Document 1 does not contain sulfate ions. Therefore, in the experiment, not the solution described in Reference Document 1 but the “new corrosion test solution (pH 5)” described in Reference Document 3 was used as the test solution in order to accurately evaluate the performance of each of the paints.

### Experimental Results

Experimental results are presented in the following table. Rust of the coating film damaged portion was classified into “flow rust>red rust>red point rust>white rust” in order of progress of corrosion. As compared with the coated test piece No. 1 to which no additive A was added, progress of corrosion was remarkably reduced in the coated test pieces to which basic magnesium carbonate or sodium hydrogen phosphate was added as additive A. Basic magnesium carbonate is a compound represented by 4MgCO₃·Mg(OH)₂·5H₂O, and calcium hydrogen phosphate is CaHPO₄, which both exhibit weak basicity when being dissolved in water.

Since zinc is an amphoteric metal and is dissolved in a strong base, the base added for the purpose of neutralizing rainwater in embodiments of the present invention is desirably a weak base. It is considered that when basic magnesium carbonate or calcium hydrogen phosphate was used, a corrosion product of zinc could be stabilized without proceeding corrosion of zinc. However, no effect was observed in the coated test piece to which sodium hydrogen carbonate or dihydrogen phosphate was added as additive A. A reason why no effect was observed is considered to be as follows. That is, sodium hydrogen carbonate and dihydrogen phosphate are weak bases, but 5 g or more of each of sodium hydrogen carbonate and dihydrogen phosphate was dissolved in 100 mL of water, and voids were generated in a coating film due to dissolution of the salts in the water, resulting in a large decrease in an anticorrosion property.

In addition to basic magnesium carbonate and calcium hydrogen phosphate, barium carbonate, barium hydrogen phosphate, beryllium carbonate, calcium carbonate, calcium phosphate, lithium carbonate, lithium phosphate, magnesium carbonate, magnesium hydroxide, magnesium oxide, magnesium phosphate, and the like can be considered to be used as additive A. These can be used in a form of anhydrides or hydrates. In addition, the basic substance can also be used in a form of a complex in which two or more types of the above-described substances are combined. For example, basic magnesium carbonate is a hydrate of a composite salt of magnesium carbonate and magnesium hydroxide represented by 4MgCO₃·Mg(OH)₂·5H₂O or the like, but this ratio is not limited to 4:1:5, and can be, for example, 3:1:3.

In addition, it was confirmed that progress of corrosion was further suppressed when additive B was added in addition to additive A. It is considered that the gordaite generated by supplying sulfate ions of additive B was stabilized in a basic atmosphere, and exhibited a high anticorrosion property. When (A+B)≤32, the anticorrosive effect was improved. However, when (A+B)=48, red rust was generated in the blasted SS400 steel sheet, flow rust was generated in the post-corrosion grade-2 base-adjusted steel sheet, and no effect was confirmed. This is considered to be because when the content of a salt increases, a decrease in an anticorrosion property due to generation of voids in a coating film when the salt is dissolved in the water is large.

TABLE 1

| | | | | | | Post-corrosion |
|---|---|---|---|---|---|---|
| | | | | | Blasted SS400 | grade-2 base- |
| No. | A | W_{A} [g] | B | W_{B} [g] | steel sheet | adjusted steel sheet |
| 1 | Not added | — | Not added | — | Flow rust | Flow rust |
| 2 | Basic magnesium | 0.5 | Not added | — | Red rust | Flow rust (lighter |
| | carbonate | | | | | than No. 1) |
| 3 | Same as above | 8 | Same as above | — | Red point rust | White rust + Red |
| | | | | | | point rust |
| 4 | Same as above | 32 | Same as above | — | Red point rust | Red rust |
| 5 | Same as above | 48 | Same as above | — | Red rust | Flow rust |
| 6 | Calcium hydrogen | 0.5 | Not added | — | Red rust | Flow rust (lighter |
| | phosphate | | | | | than No. 1) |
| 7 | Same as above | 8 | Same as above | — | Red point rust | White rust + Red |
| | | | | | | point rust |
| 8 | Same as above | 32 | Same as above | — | Red point rust | Red rust |
| 9 | Same as above | 48 | Same as above | — | Red rust | Flow rust |
| 10 | Sodium hydrogen | 8 | Same as above | — | Red rust | Flow rust |
| | carbonate | | | | | |
| 11 | Disodium hydrogen | 8 | Same as above | — | Red rust | Flow rust |
| | phosphate | | | | | |
| 12 | Basic magnesium | 16 | Calcium sulfate | 16 | White rust | White rust + Red |
| | carbonate | | dihydrate | | | point rust |
| 13 | Basic magnesium | 16 | Sodium sulfate | 16 | White rust | Red point rust |
| | carbonate | | | | | |
| 14 | Calcium hydrogen | 16 | Calcium sulfate | 16 | White rust | White rust + Red |
| | phosphate | | dihydrate | | | point rust |
| 15 | Calcium hydrogen | 16 | Sodium sulfate | 16 | White rust + Red | Red rust |
| | phosphate | | | | point rust | |
| 16 | Basic magnesium | 8 | Calcium sulfate | 8 | White rust | White rust |
| | carbonate | | dihydrate | | | |
| 17 | Basic magnesium | 24 | Calcium sulfate | 24 | Red rust | Flow rust |
| | carbonate | | dihydrate | | | |

Note that basic magnesium carbonate may be used as an extender pigment (enhancer, reinforcing agent, or modifier), but embodiments of the present invention focus on the fact that basic magnesium carbonate is slightly dissolved in water to exhibit weak basicity, and aims for neutralization with basic magnesium carbonate. In addition, when a large amount of material other than a zinc powder is added to a zinc powder-containing paint such as the zinc rich paint, it is difficult to ensure electrical conduction between the zinc powders and between the zinc powder and the steel material, which is not desirable. In general, the amount of an extender pigment other than the zinc powder is very small even if the extender pigment is added. Therefore, embodiments of the present invention cannot be easily inferred.

In addition, when a corrosion rate of zinc is excessively lowered by pH adjustment, there is a possibility that zinc cannot exhibit a sufficient anticorrosion property at a coating film damaged portion or the like. However, in embodiments of the present invention, the anticorrosive effect of zinc could be confirmed even at a coating film damaged portion, and it has been indicated for the first time that a sufficient anticorrosive effect can be obtained while suppressing excessive corrosion of zinc, which cannot be easily inferred.

The binder of SD Zinc 500 Mild used in Examples of embodiments of the present invention is an epoxy resin, but embodiments of the present invention can use any resin regardless of the type of resin. Examples of the resin include an epoxy resin, a polyurethane resin, a fluorocarbon resin, an oil-modified alkyd resin, a phthalic acid resin, an unsaturated polyester resin, a silicone resin, a modified epoxy resin, an alkyl silicate, an alkali silicate, an acrylic silicate, an acrylic styrene resin, a styrene resin, a polyester resin, a chlorinated rubber, a melamine resin, and a polyamide resin, which are used as binders of a paint.

In particular, an organic binder such as an epoxy resin, a polyurethane resin, an acrylic styrene resin, a styrene resin, an acrylic resin, or a polyamide resin, and an inorganic binder such as an alkyl silicate or an alkali silicate, which are used as binders of the zinc rich paint, are suitably used. Among these binders, particularly, the organic binder that does not generate voids in a coating film does not use gordaite for filling voids inside the coating film, and efficiently protects a coating film surface. Therefore, a larger effect can be obtained when the organic binder is applied to the zinc rich paint. When the inorganic binder is used, voids may be generated. However, in such a case, the effect can be obtained by performing mist coating with a predetermined resin to fill the voids.

The basic substance to be added is desirably one that provides a saturated aqueous solution having a pH of 12 or less when being dissolved in water. This is because when water condensed on a coating film remains for a long time, zinc which is an amphoteric metal is rather dissolved. Since it is also difficult to obtain the effect when the basicity of the basic substance is too weak, it is particularly desirable to use a basic substance that provides a saturated aqueous solution having a pH of 9 to 12 when being dissolved in water.

As an additive to a zinc powder-containing paint for suppressing the corrosion rate of zinc, it is common to add a metal such as aluminum or magnesium aiming at making the composition of a corrosion product a composition with higher protection. The inventors have studied to improve the anticorrosion property of the paint by stabilizing a protective rust rather than generating a large amount of the protective rust. Specifically, for the purpose of neutralizing weakly acidic rainwater, the inventors examined addition of an inorganic material (basic substance) that exhibits basicity. This is because the inventors focused on the fact that the stability of the protective rust depends on pH, and considered that the corrosion rate of zinc can be suppressed by adjusting the pH such that the protective rust is stabilized to improve the anticorrosion property. This cannot be easily inferred. In addition, the inventors have experimentally revealed for the first time that it is necessary to use a weak base having low solubility in water for pH adjustment.

Furthermore, the inventors have experimentally revealed for the first time that even a corrosion product of zinc can more effectively enhance an anticorrosion property by intentionally generating a large amount of gordaite having a particularly high anticorrosion property, adding sulfate ions necessary for generation of the gordaite as sodium sulfate or calcium sulfate, and then adding the basic substance according to embodiments of the present invention in order to stabilize the gordaite in a basic atmosphere. Note that the inventors have also experimentally revealed that excessive addition of a sulfate and a basic substance decreases the anticorrosion property because the sulfate and the basic substance generate voids in a coating film when being dissolved in water.

In addition, in the above description, the organic zinc rich paint containing a zinc powder at a high concentration (heating residue: 70 wt % or more) has been exemplified. However, it can be easily inferred that, also in a zinc rich primer for forming a thinner coating film or a zinc dust paint having a lower zinc content than a case where the zinc rich paint is used, a similar effect can be obtained by adding a similar basic substance to the above to stabilize a corrosion product of zinc.

In a paint having a low content of zinc powder, it is considered that it is difficult to ensure electrical conduction between the zinc powders and between the zinc powder and the steel material, and the sacrificial anticorrosive action of zinc is reduced, but the anticorrosive effect due to the protective film action of zinc can be obtained in almost proportion to the addition amount of zinc powder. It is considered that by adding a basic substance to a paint having a low content of zinc powder, a paint that exhibits an excellent anticorrosion property while suppressing the use amount of expensive zinc powder can be obtained. In order to obtain a sufficient effect, the content of zinc powder is desirably 20% or more. However, when the content of zinc powder is 50% or more, an anticorrosion property not much different from that of a paint in which the content of zinc powder is 70% or more can be obtained.

When a basic substance is added to a paint having a low zinc content and is used, it is considered that a larger effect can be obtained by using the paint as a material for mist coating used for overcoating a material having a high zinc concentration, such as a zinc rich paint, a zinc rich primer, or a hot dip galvanized material, or filling voids when an inorganic zinc rich paint is used.

As described above, according to embodiments of the present invention, a zinc powder-containing paint that maintains an anticorrosive effect for a long period of time can be manufactured inexpensively and easily because an inorganic material (basic substance) that is water-soluble and exhibits alkalinity when being dissolved in water is added to the paint for use.

Note that it is obvious that embodiments of the present invention are not limited to the embodiments described above, but can be modified and combined in many ways by a person having ordinary knowledge in the art within the technical idea of the present invention.

### REFERENCE DOCUMENTS

[Reference Document 1] Takashi Miwa, Yukitoshi Takeshita, and Azusa Ishii, “Technical Report: Various Accelerated Corrosion Tests Using Coated Steel Sheet and Comparison of Corrosion Behavior by Outdoor Exposure Tests”, Corrosion Control, pp. 61, 12, and 449-455, 2017.
[Reference Document 2] N. S. Azmat et al., “Corrosion of Zn under acidified marine droplets”, Corrosion Science, vol. 53, pp. 1604-1615, 2011.
[Reference Document 3] Takashi Miwa, Azusa Ishii, and Hiroshi Koizumi, “Study on Accelerated Corrosion Test Solution for More Accurate Reproduction of Atmospheric Corrosion of Zinc in Salt Harm Environment”, 2018 Collection of Lecture on Materials and Environment B-308, pp. 193-196, 2018.

1.-8. (canceled)

9. A paint comprising:
a zinc powder;
a binding agent comprising a resin; and
an inorganic material that is water-soluble and exhibits alkalinity when being dissolved in water.

10. The paint according to claim 9, wherein the inorganic material provides a saturated aqueous solution having a pH of 12 or less.

11. The paint according to claim 10, wherein the inorganic material comprises barium carbonate, barium hydrogen phosphate, beryllium carbonate, calcium carbonate, calcium hydrogen phosphate, calcium phosphate, lithium carbonate, lithium phosphate, magnesium carbonate, basic magnesium carbonate, magnesium hydroxide, magnesium oxide, magnesium phosphate, or a combination thereof.

12. The paint according to claim 11, wherein a content of the inorganic material is 0.5 to 32 g with respect to 100 g of a heating residue of a coating film, wherein the 100 g of the heating residue excludes the inorganic material.

13. The paint according to claim 12, further comprising a sulfate having a solubility in water of less than 5 g/100 ml.

14. The paint according to claim 13, wherein the sulfate comprises sodium sulfate or calcium sulfate.

15. The paint according to claim 14, wherein a content of the sulfate is 0.5 to 32 g with respect to the 100 g of the heating residue of the coating film, wherein the 100 g of the heating residue excludes the inorganic material and the sulfate to be added.

16. The paint according to claim 15, wherein:
the inorganic material comprises calcium hydrogen phosphate, basic magnesium carbonate, or a mixture of magnesium carbonate and magnesium hydroxide; and
the sulfate comprises calcium sulfate.

17. The paint according to claim 16, wherein a content of the inorganic material is 0.5 to 16 g with respect to the 100 g of the heating residue of the coating film, and wherein a content of the sulfate is 0.5 to 16 g with respect to the 100 g of the heating residue of the coating film, wherein the 100 g of the heating residue excludes the inorganic material and the sulfate to be added.

18. A coating material comprising:
a zinc powder;
a binding agent comprising a resin; and
an inorganic material that is water-soluble and exhibits alkalinity when being dissolved in water, wherein a content of the inorganic material is 0.5 to 32 g with respect to 100 g of a heating residue of a coating film that excludes the inorganic material.

19. The coating material according to claim 18, wherein the inorganic material provides a saturated aqueous solution having a pH of 12 or less.

20. The coating material according to claim 19, wherein the inorganic material comprises barium carbonate, barium hydrogen phosphate, beryllium carbonate, calcium carbonate, calcium hydrogen phosphate, calcium phosphate, lithium carbonate, lithium phosphate, magnesium carbonate, basic magnesium carbonate, magnesium hydroxide, magnesium oxide, magnesium phosphate, or a combination thereof.

21. The coating material according to claim 20, further comprising a sulfate having a solubility in water of less than 5 g/100 ml.

22. The coating material according to claim 21, wherein a content of the sulfate is 0.5 to 32 g with respect to the 100 g of the heating residue of the coating film, wherein the 100 g of the heating residue excludes the inorganic material and the sulfate to be added.

23. The coating material according to claim 22, wherein:
the inorganic material comprises calcium hydrogen phosphate, basic magnesium carbonate, or a mixture of magnesium carbonate and magnesium hydroxide;
the sulfate comprises calcium sulfate; and
a content of the inorganic material is 0.5 to 16 g with respect to the 100 g of the heating residue of the coating film and a content of the sulfate is 0.5 to 16 g with respect to the 100 g of the heating residue of the coating film, wherein the 100 g of the heating residue excludes the inorganic material and the sulfate to be added.

24. A coating material comprising:
a zinc powder;
a binding agent comprising a resin;
an inorganic material that is water-soluble and exhibits alkalinity when being dissolved in water; and
a sulfate having a solubility in water of less than 5 g/100 ml.

25. The coating material according to claim 24, wherein:
the inorganic material provides a saturated aqueous solution having a pH of 12 or less; and
the inorganic material comprises barium carbonate, barium hydrogen phosphate, beryllium carbonate, calcium carbonate, calcium hydrogen phosphate, calcium phosphate, lithium carbonate, lithium phosphate, magnesium carbonate, basic magnesium carbonate, magnesium hydroxide, magnesium oxide, magnesium phosphate, or a combination thereof.

26. The coating material according to claim 24, wherein a content of the inorganic material is 0.5 to 32 g with respect to 100 g of a heating residue of a coating film, wherein the 100 g of the heating residue excludes the inorganic material.

27. The coating material according to claim 24, wherein:
the sulfate comprises sodium sulfate or calcium sulfate; and
a content of the sulfate is 0.5 to 32 g with respect to 100 g of a heating residue of a coating film, wherein the 100 g of the heating residue excludes the inorganic material and the sulfate to be added.

28. The coating material according to claim 24, wherein:
the inorganic material comprises calcium hydrogen phosphate, basic magnesium carbonate, or a mixture of magnesium carbonate and magnesium hydroxide;
the sulfate comprises calcium sulfate; and
a content of the inorganic material is 0.5 to 16 g with respect to 100 g of a heating residue of a coating film and a content of the sulfate is 0.5 to 16 g with respect to the 100 g of the heating residue of the coating film, wherein the 100 g of the heating residue excludes the inorganic material and the sulfate to be added.
